(19) United States
(12) Patent Application Publication
(10) Pub. No.: US 2011/0055089 A1
(43) Pub. Date: Mar. 3, 2011

(54) COMPUTER READABLE MEDIUM AND WORK STATE DETERMINATION DEVICE

(75) Inventor: Ryouji TAGUCHI, Kanagawa (JP)

(73) Assignee: FUJI XEROX CO., LTD., Tokyo (JP)

(21) Appl. No.: 12/732,822

(22) Filed: Mar. 26, 2010

(30) Foreign Application Priority Data
Aug. 26, 2009 (JP) 2009-195658

(51) Int. Cl. G06Q 10/00; G06Q 99/00

(52) U.S. Cl. 705/301; 705/342

(57) ABSTRACT

A computer readable medium storing a program causing a computer to execute a process for determining execution states of plural works which are performed in order, the process includes: inputting written information of a paper document, the written information being written by an operator of at least one of the plural works, and indicating contents of the at least one of the plural works; determining execution states of the at least one of the plural works indicated in the written information, based on the input written information and the order of the plural works; and updating work state information indicating execution states of the plural works based on the determination.

### CROSS-REFERENCE TO RELATED APPLICATIONS

This application is based on and claims priority under 35 USC 119 from Japanese Patent Application No. 2009-195658 filed on Aug. 26, 2009.

### BACKGROUND

1. Technical Field

The present invention relates to a work state determination program and a work state determination device.

2. Related Art

A technique for permitting the use of a paper document in a series of works has been proposed.

### SUMMARY

According to an aspect of the invention, a computer readable medium storing a program causing a computer to execute a process for determining execution states of plural works which are performed in order, the process comprising: inputting written information of a paper document, the written information being written by an operator of at least one of the plural works, and indicating contents of the at least one of the plural works; determining execution states of the at least one of the plural works indicated in the written information, based on the input written information and the order of the plural works; and updating work state information indicating execution states of the plural works based on the determination.

### BRIEF DESCRIPTION OF THE DRAWINGS

Exemplary embodiment(s) of the present invention will be described in detail based on the following figures, wherein:

FIG. 1 is a schematic diagram showing a configuration example of a workflow management system according to a first exemplary embodiment of the invention;

FIG. 2 is a schematic diagram showing a configuration example of a workflow management server apparatus;

FIG. 3 is a schematic diagram showing a configuration example of a report;

FIGS. 4A and 4B are schematic diagrams showing a configuration example of workflow definition data stored in a storage section of the workflow management server apparatus;

FIGS. 5A and 5B are schematic diagrams showing a configuration example of workflow execution data stored in the storage section of the workflow management server apparatus;

FIG. 6 is a flowchart showing an operation example of a workflow management system;

FIG. 7 is a schematic diagram showing a configuration example of workflow definition data stored in the storage section of the workflow management server apparatus according to a second exemplary embodiment of the invention;

FIG. 8 is a flowchart showing an operation example of the workflow management system;

FIG. 9 is a schematic diagram showing a configuration example of workflow definition data stored in the storage section of the workflow management server apparatus according to a third exemplary embodiment of the invention;

FIGS. 10A and 10B are schematic diagrams showing a configuration example of workflow execution data stored in the storage section of the workflow management server apparatus.

FIG. 11 is a flowchart showing an operation example of the workflow management system;

FIGS. 12A and 12B are schematic diagrams showing a configuration example of workflow definition data stored in the storage section of the workflow management server apparatus according to a fourth exemplary embodiment of the invention;

FIGS. 13A to 13C are schematic diagrams showing a configuration example of workflow execution data stored in the storage section of the workflow management server apparatus; and

FIG. 14 is a flowchart showing an operation example of the workflow management system.

### DETAILED DESCRIPTION

### First Exemplary Embodiment

### Configuration of Workflow Management System

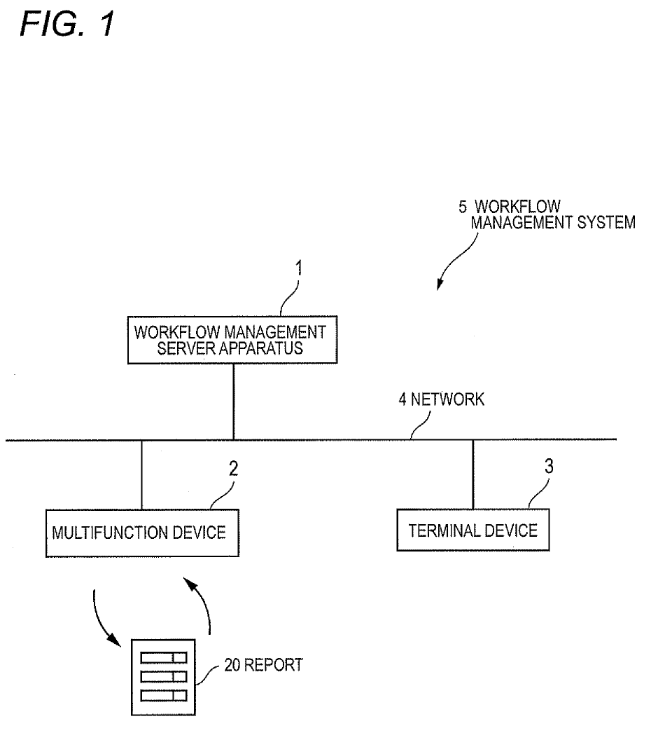

FIG. 1 is a schematic diagram showing a configuration example of a workflow management system according to a first exemplary embodiment of the invention.

This workflow management system 5 comprises a workflow management server apparatus 1, a multifunction device 2 as an input/output device or an image forming device, and a terminal device 3, which are interconnected to be communicable with each other via a network 4.

The workflow management server apparatus 1 is an information processing apparatus having the electronic components such as a CPU and a storage section having a function of managing a series of works (hereinafter referred to as a “workflow”) using an electronic document and a paper document.

The multifunction device 2 has multiple functions such as a print function and an optical operation function for performing the input/output of paper document for use in the workflow.

The terminal device 3 makes access to the workflow management server apparatus 1 and performs a work using the electronic document, and has an operation section for inputting the operation, a display section such as a liquid crystal display, and a control section having the electronic components such as the CPU and the storage section. The terminal device 3 may be, for example, a personal computer, a PDA (Personal Digital Assistant), or a portable telephone set. Though one terminal device 3 is illustrated in the drawing, a plurality of terminal devices may be provided.

The network 4 may be a LAN (Local Area Network), or the internet, irrespective of wire or wireless.

Herein, a “workflow” is the flow along which the respective definite workers execute or perform a plurality of works based on a preset sequence. The work is performed by perusing and editing the electronic document or perusing and writing in the paper document using the terminal device 3.

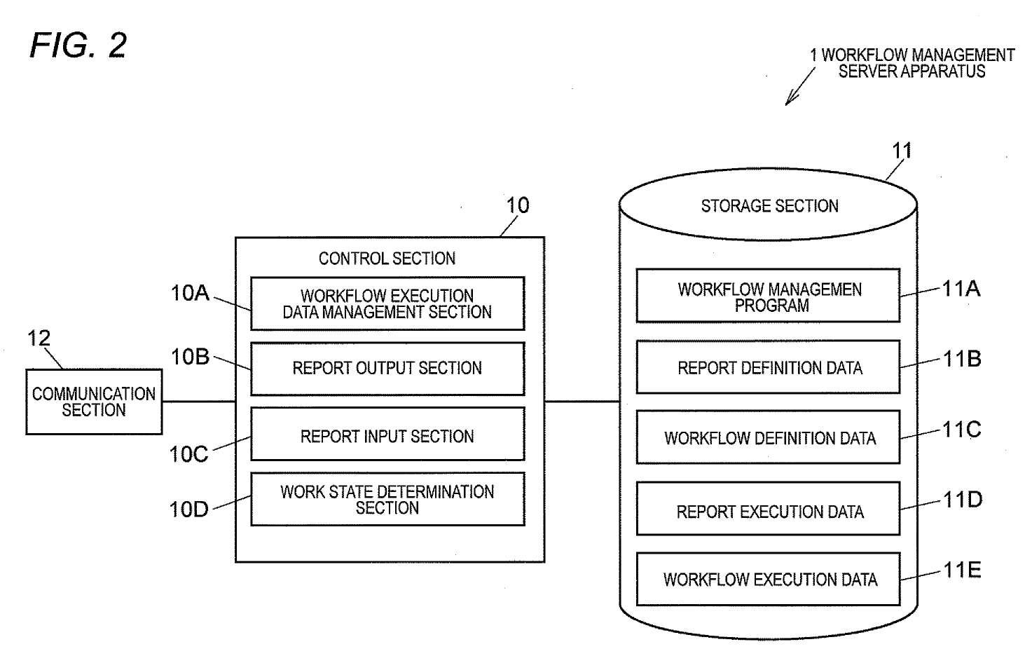

FIG. 2 is a schematic diagram showing a configuration example of the workflow management server apparatus.

The workflow management server apparatus 1 has a control section 10, composed of a CPU (Central Processing Unit), for controlling each section and performing various kinds of program, a storage section 11, composed of a storage medium such as an HDD (Hard Disk Drive) or a flash memory, for storing information, and a communication section 12 for communicating with the outside via the network 4.

The control section 10 functions as workflow execution data management section 10A, report output section 10B, report input section 10C and work state determination section 10D by being executed a workflow management program 11A as will be described later.

The workflow execution data management section 10A manages the state of work included in the workflow, based on the input content of the worker into the electronic document or paper document.

The report output section 10B instructs the multifunction device 2 to generate image information for printing a report 20 of paper document from report definition data 11B as the electronic document for use in the workflow, and to output the report 20 using the image information.

The report input section 10C inputs the report by converting the information described in the report 20 scanned in the multifunction device 2 into the electronic document through a unit such as an OCR (Optical Character Reader).

The work state determination section 10D determines whether any work in the workflow is ended and whether any work is being executed, based on the input content described in the report 20 and workflow definition data 11C.

The storage section 11 stores a workflow management program 11A for causing the control section 10 to operate as each above described section, the report definition data 11B composed of character information or image information for printing the report 20, the workflow definition data 11C defining the state of work in the workflow and the worker or condition of each work, the report execution data 11D that is the electronic document obtained by inputting the report 20 into the multifunction device 2, converting the note written into the report 20 into note information through a unit such as OCR, and combining the note information with the information before output, and the workflow execution data 11E indicating the state of each work included in the workflow.

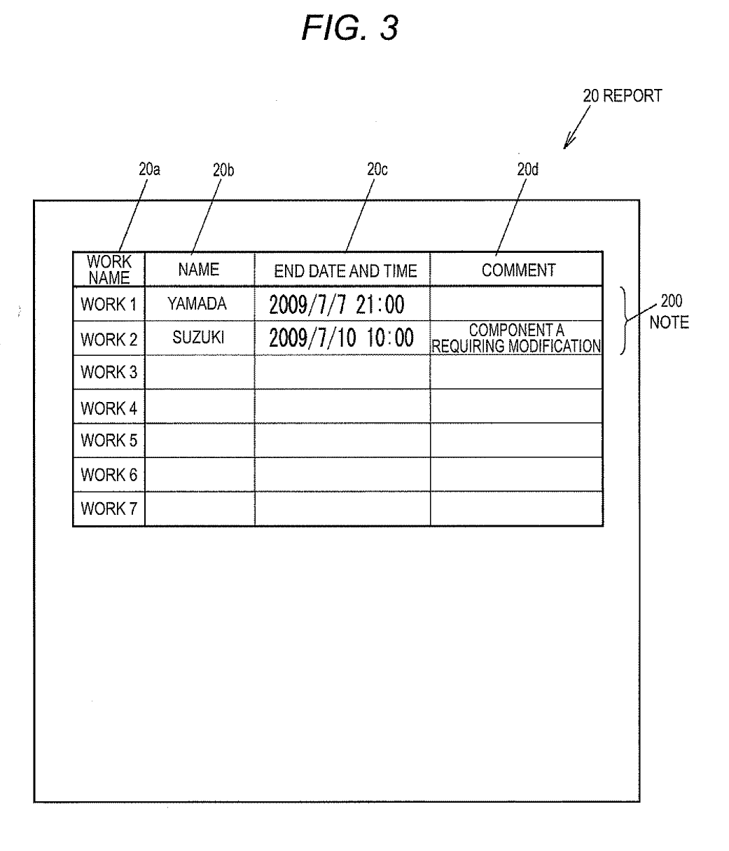

FIG. 3 is a schematic diagram showing a configuration example of the report 20. The report 20 as shown has a note 200 written by the worker who executed the workflow, for example, and has a work name column 20a indicating the work in the workflow, a name column 20b of the worker who performs the work, an end date time column 20c indicating the date and time when the work is ended, and a comment column 20d written by the worker who performs the work. The report 20 is affixed with a component or book required to circulate, for example, in which each worker performs the work of confirmation on the component or book to write the note 200.

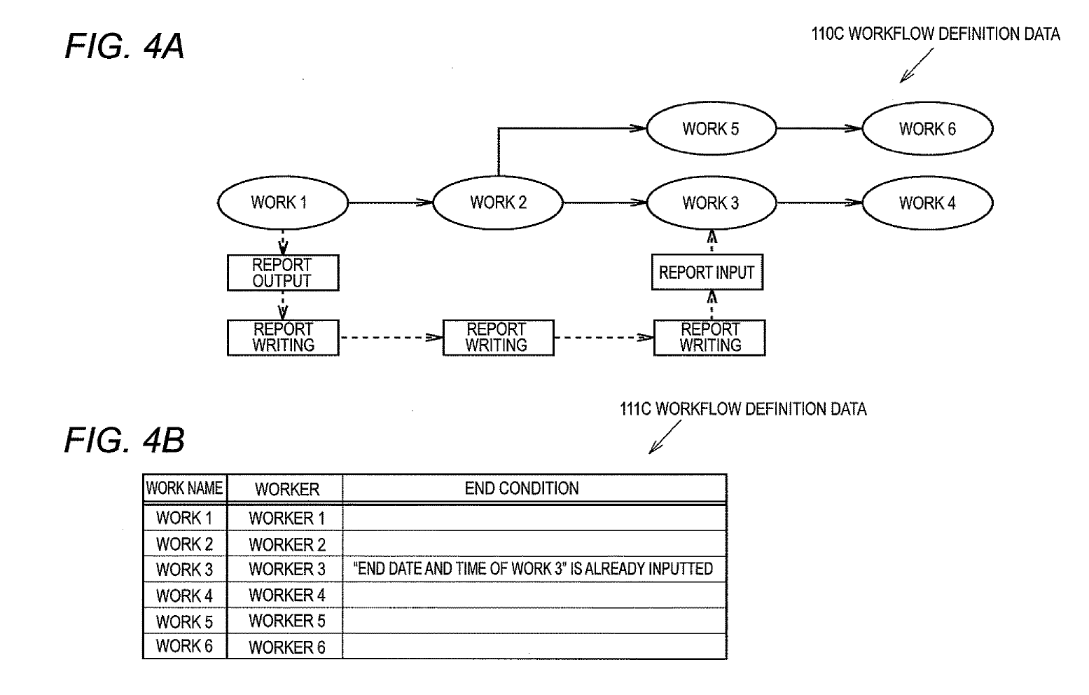

FIGS. 4A and 4B are schematic diagrams showing a configuration example of the workflow definition data 11C stored in the storage section 11 of the workflow management server apparatus 1.

The workflow definition data 110C as shown in FIG. 4A is the data defining the sequence of works 1 to 6, and is defined to proceed in the sequence of work 1 and work 2, branch to work 3 or work 5, and respectively proceed to work 4 or work 6, for example. When proceeding from work 2 to work 3 or work 5, both works may be executed, or only the workflow following the ahead going work may be executed. It is assumed that the workflow does not proceed to the next work unless each work is ended in accordance with the sequence.

Also, the workflow definition data 110C is defined such that the report output and the report writing is executed by the worker of the work 1 in the work 1, the report writing is executed in the work 2 and the work 3, like the work 1, and the report input is executed by the worker of the work 3 in the work 3. Also, the definition of the report output, report input and report writing operations is not made beforehand, but may be additionally made in accordance with the operation of the worker.

The workflow definition data 111C as shown in FIG. 4B has a work name indicating the name of work included in the workflow, a worker indicating the user who executes each work, and the end condition indicating the condition required to end the state of work.

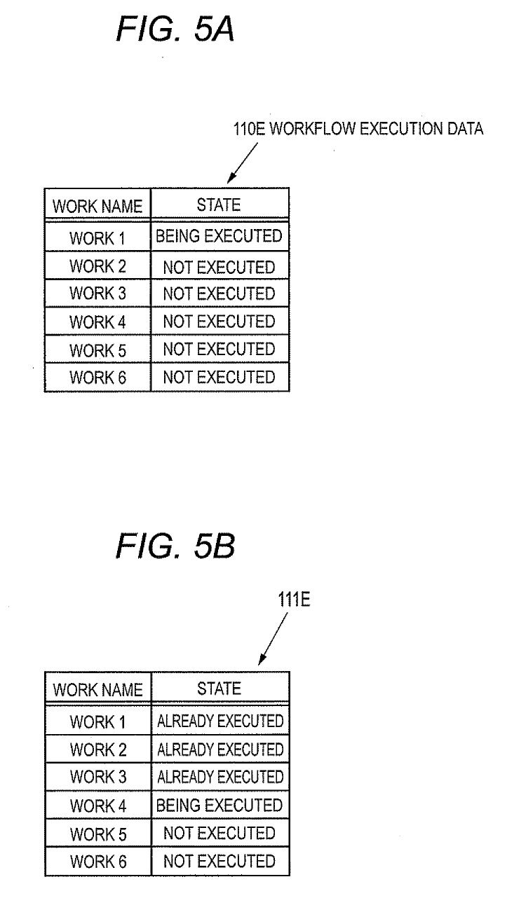

FIGS. 5A and 5B are schematic diagrams showing a configuration example of the workflow execution data 11E stored in the storage section 11 of the workflow management server apparatus 1. FIGS. 5A and 5B show workflow execution data 110E, 111E in different states from the workflow execution data 11E of FIG. 2.

The workflow execution data 110E as shown in FIG. 5A indicates the state of workflow execution data when the work 1 is being executed, in which the works following the work 2 are not yet executed when the works 1 to 6 proceed in the sequence as shown in FIG. 4A, for example.

The workflow execution data 111E as shown in FIG. 5B indicates the state of workflow execution data when the work 4 is being executed, in which the work 5 and the work 6 are not yet executed when the works 1 to 4 proceed in the sequence as shown in FIG. 4A, for example.

(Operation of Workflow Management System)

The operation of the workflow management system 5 will be described below with reference to the drawings.

(1) Output of Report

First of all, the workflow is executed along the workflow definition data 110C as shown in FIG. 4A. The user who executes the work 1, namely, the worker 1, operates the operation section of the terminal device 3, and makes a request to start management of the workflow. The control section of the terminal device 3 requests the workflow management server apparatus 1 to execute the workflow management program 11A. Next, the worker 1 operates the terminal device 3 to request the workflow management server apparatus 1 to output the report 20 from the multifunction device 2. The workflow execution data management section 10A of the workflow management server apparatus 1, upon receiving the request, recognizes the work being executed at the time of reference as 1 by referring to the workflow execution data 110E as shown in FIG. 5A as one example of the workflow execution data 11E. Next, the report output section 10B reads the report definition data 11B of the electronic document related to the work 1 from the storage section 11, and sends it to the multifunction device 2 to output the report 20 from the multifunction device 2.

Next, the workers 1 to 3 execute the works 1 to 3 of confirming the component or book for the report 20 outputted from the multifunction device 2 in the sequence of workers 1, 2 and 3, and writes the note 200 into the report 20, as shown in FIG. 3. In addition to the note 200 as shown in FIG. 3, the worker 3 further writes, and then inputs the report 20 into the multifunction device 2. The multifunction device 2 reads the report 20, and sends the read information to the workflow management server apparatus 1.

(2) Operation of Workflow Management Server Apparatus After Reading Report

The operation of the workflow management server apparatus 1 after the report 20 is inputted into the multifunction device 2 will be described below.

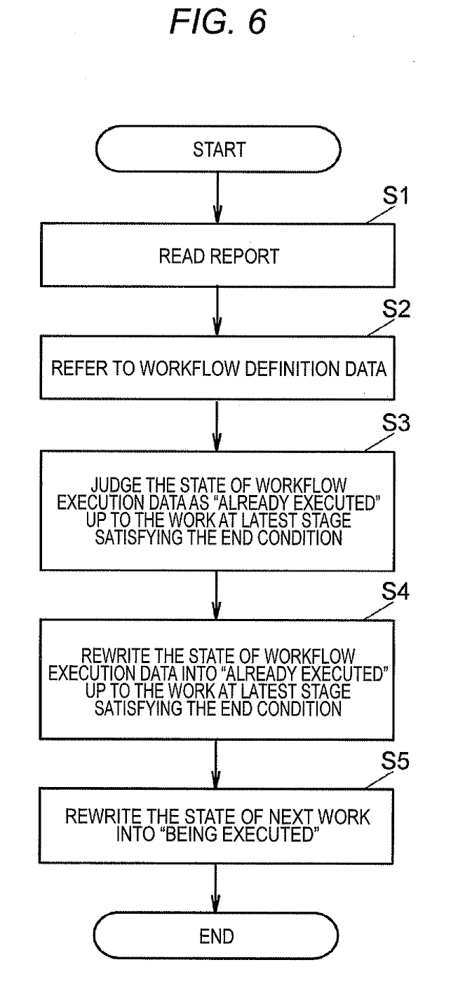

FIG. 6 is a flowchart showing an operation example of the workflow management system 5.

First of all, the report input section 10C converts an image applicable to the note 200 of information received from the multifunction device 2 into the written information such as text data through the OCR and confirms the work corresponding to the written information and the content of written information (S1).

Next, the work state determination section 10D refers to the workflow definition data 111C as shown in FIG. 4B (S2). And the work state determination section 10D determines as “already executed”, the works up to the work at the latest stage satisfying the end condition in accordance with the content of written information of the report 20 confirmed at step S1 (S3). For example, since the work 3 in which the note 200 is written satisfies the end condition that the “end date and time of the work 3” is already inputted, the work state determination section 10D determines the works 1 to 3 as “already executed”.

Next, the workflow execution data management section 10A makes the state of the work determined as already executed by the work state determination section 10D at step S3 as “already executed” (S4), and makes the state of the next work of the work in which the state of the work is made “already executed” at step S4 as “being executed”, and rewrites the workflow execution data 110E into the workflow execution data 111E as shown in FIG. 5B (S5).

### Second Exemplary Embodiment

A second exemplary embodiment is different from the first exemplary embodiment in that the user (worker 3) who inputs the report 20 into the multifunction device 2 designates the work for enabling the work state determination section 10D to make the determination before the work 3 if the note 200 extends to the work 4.

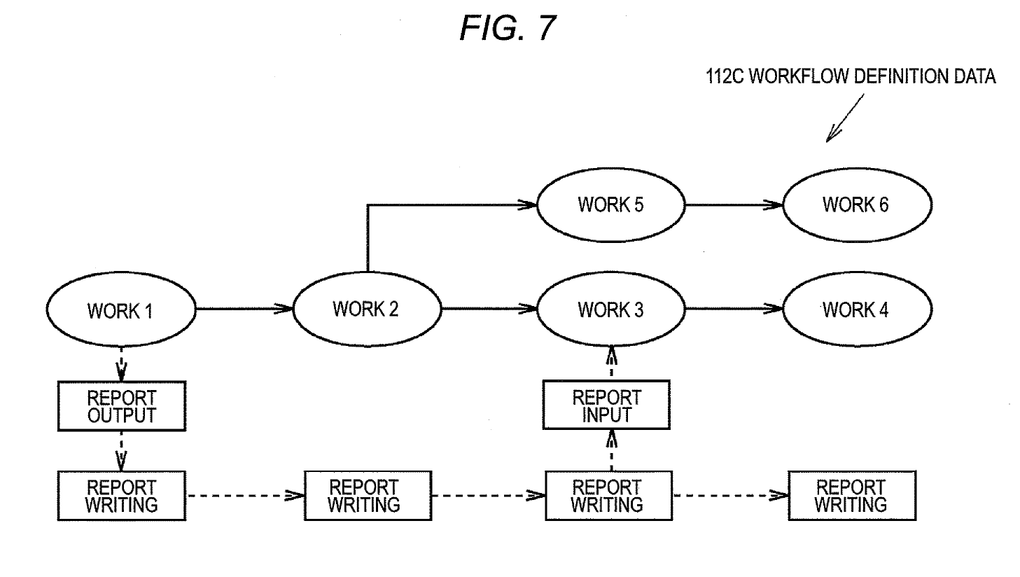

FIG. 7 is a schematic diagram showing a configuration example of the workflow definition data 11C stored in the storage section 11 of the workflow management server apparatus 1 according to the second exemplary embodiment of the invention.

The workflow definition data 112C as shown in FIG. 7 is the data defining a procedure of the works 1 to 6, and is defined to proceed in the sequence of work 1 and work 2, branch to work 3 or work 5, and respectively proceed to work 4 or work 6, for example. When proceeding from work 2 to work 3 or work 5, both works may be executed, or only the workflow following the ahead going work may be executed.

Also, the workflow definition data 112C is defined such that the report output and the report writing are executed by the worker of the work 1 in the work 1, the report writing is executed in the work 2, the work 3 and the work 4, like the work 1, and the report input is executed, with the work 3 designated, by the worker of the work 3 in the work 3. Also, the definition of the report output, report input and report writing operations is not made beforehand, but may be additionally made in accordance with the operation of the worker.

(Operation of Workflow Management System)

The works 1 to 4 are executed for the outputted report 20 in the sequence of the workers 1 to 4 in the same way as the first exemplary embodiment, and the note 200 is written into the report 20 as shown in FIG. 3. In addition to the note 200 as shown in FIG. 3, the workers 3 and 4 further write, and then the worker 3 inputs the report 20 into the multifunction device 2 by designating the work 3 at the time of input. The multifunction device 2 reads the report 20, and sends the read information to the workflow management server apparatus 1.

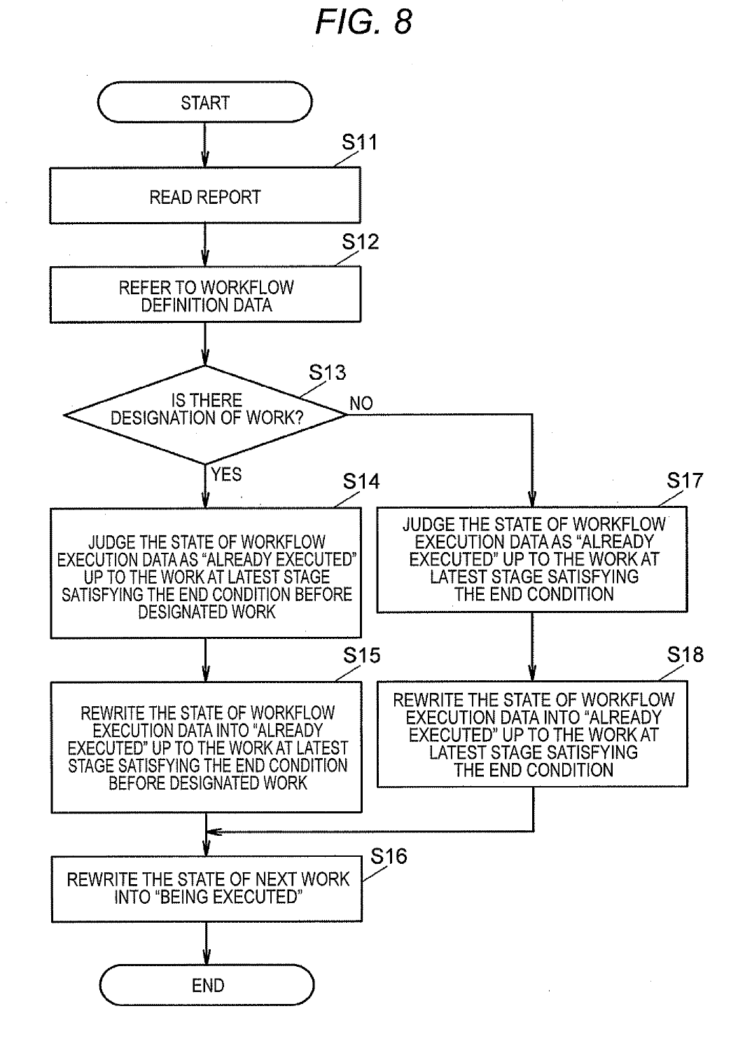

FIG. 8 is a flowchart showing an operation example of the workflow management system 5.

First of all, the report input section 10C converts the information received from the multifunction device 2 into the written information and confirms the work corresponding to the written information and the content of written information, as well as reads the work 3 designated by the worker 3 as designated work identification information (S11).

Next, the work state determination section 10D refers to the workflow definition data 112C as shown in FIG. 4B (S12), and if there is the designated work identification information in inputting the report 20, namely, the designation of the work by the worker (S13: Yes), determines the works up to the work at the latest stage satisfying the end condition in accordance with the content of the note 200 of the report 20 confirmed at step S11, for example, the end condition of the work 3 that the “end date and time of the work 3” is already inputted, that is, the work 3 in which the note 200 is written, as already executed (S14).

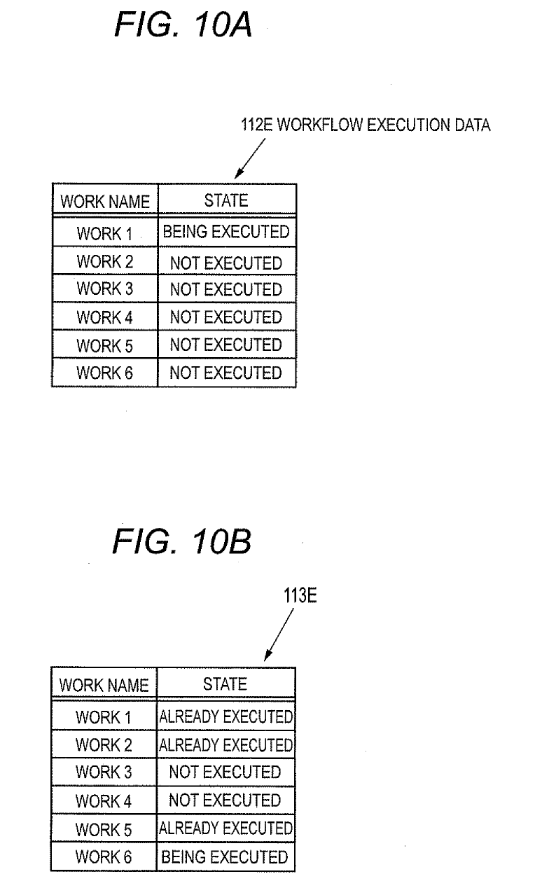

Next, the workflow execution data management section 10A makes the state of the work determined as already executed by the work state determination section 10D at step S14 as “already executed” (S15), and makes the state of the next work of the work in which the state of the work is made “already executed” at step S15 as “being executed”, and rewrites the workflow execution data 112E as shown in FIG. 10A into the workflow execution data 113E as shown in FIG. 10B (S16). Also, it is assumed that even if the writing exists in the work 4, the work 4 is being executed.

Also, if there is no designation of the work by the worker who inputs the report 20 (S13: No), the work state determination section 10D determines as “already executed”, the works up to the work at the latest stage satisfying the end condition in accordance with the content of the note 200 of the report 20 confirmed at step S11 (S17) in the same way as the first exemplary embodiment. For example, since the end condition of the work 4 is not set in the workflow definition data 111c, the work 4 is regarded as a work satisfying the end condition thereof based on the note 200 of the work 4 is written. That is, the work state determination section 10D determines the works 1 to 4 as “already executed.”

Next, the workflow execution data management section 10A makes the state of the work determined as “already executed” by the work state determination section 10D at step S17 as “already executed” (S18).

### Third Exemplary Embodiment

A third exemplary embodiment is different from the first exemplary embodiment in considering the branch of the workflow definition data 110C from the worker 2 to the work 3 or work 5.

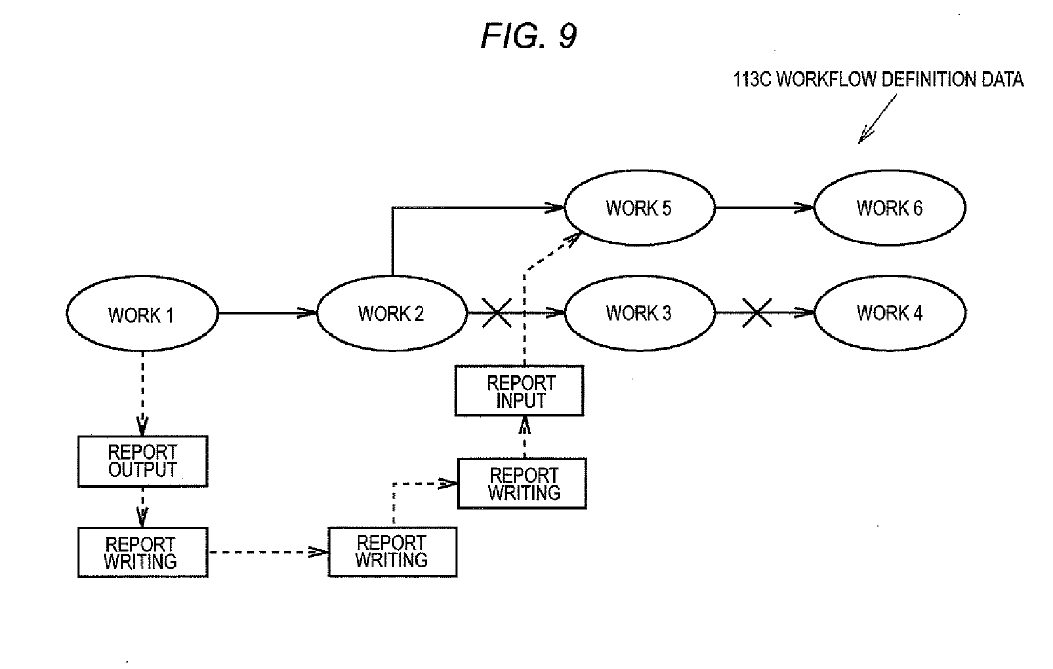

FIG. 9 is a schematic diagram showing a configuration example of the workflow definition data 113C stored in the storage section 11 of the workflow management server apparatus 1 according to the third exemplary embodiment of the invention.

The workflow definition data 113C is the data defining a procedure of the works 1 to 6, and is defined to proceed in the sequence of work 1 and work 2, branch to work 3 or work 5, and respectively proceed to work 4 or work 6, for example, as shown in FIG. 9. When proceeding from work 2 to work 3 or work 5, only the workflow following the ahead going work is executed. Herein, the workflow proceeds to the work 5, in which the work 6 following the work 5 is executed, and the works 3 and 4 are not executed.

Also, it is defined such that the report output and the report writing are executed by the worker of the work 1 in the work 1 of the workflow definition data 113C, the report writing is similarly executed in the works 2 and 5, and the report input is executed by the worker of the work 5 in the work 5. Also, the definition of the report output, report input and report writing operations is not made beforehand, but may be additionally made in accordance with the operation of the worker.

FIGS. 10A and 10B are schematic diagrams showing a configuration example of the workflow execution data 11E stored in the storage section 11 of the workflow management server apparatus 1. FIGS. 10A and 10B show the workflow execution data 112E, 113E in different states from the workflow execution data 11E of FIG. 2.

The workflow execution data 112E as shown in FIG. 10A indicates the state of workflow execution data when the work 1 is being executed, and the works following the work 2 are not yet executed when the works 1 to 6 progress in the sequence as shown in FIG. 9, for example.

The workflow execution data 113E as shown in FIG. 10B indicates the state of workflow execution data when the work 6 is being executed, in which the work 3 and the work 4 are indicated as not yet executed because the work 3 and the work 4 are not executed, the work 5 is indicated as already executed, and the work 6 is indicated as being executed.

(Operation of Workflow Management System)

The works 1, 2 and 5 are executed for the outputted report 20 in the sequence of the workers 1, 2 and 5 in the same way as the first exemplary embodiment, and the note 200 is written into the report 20 as shown in FIG. 3. In addition to the note 200 as shown in FIG. 3, the worker 5 further writes, and then inputs the report 20 into the multifunction device 2. The multifunction device 2 reads the report 20, and sends the read information to the workflow management server apparatus 1.

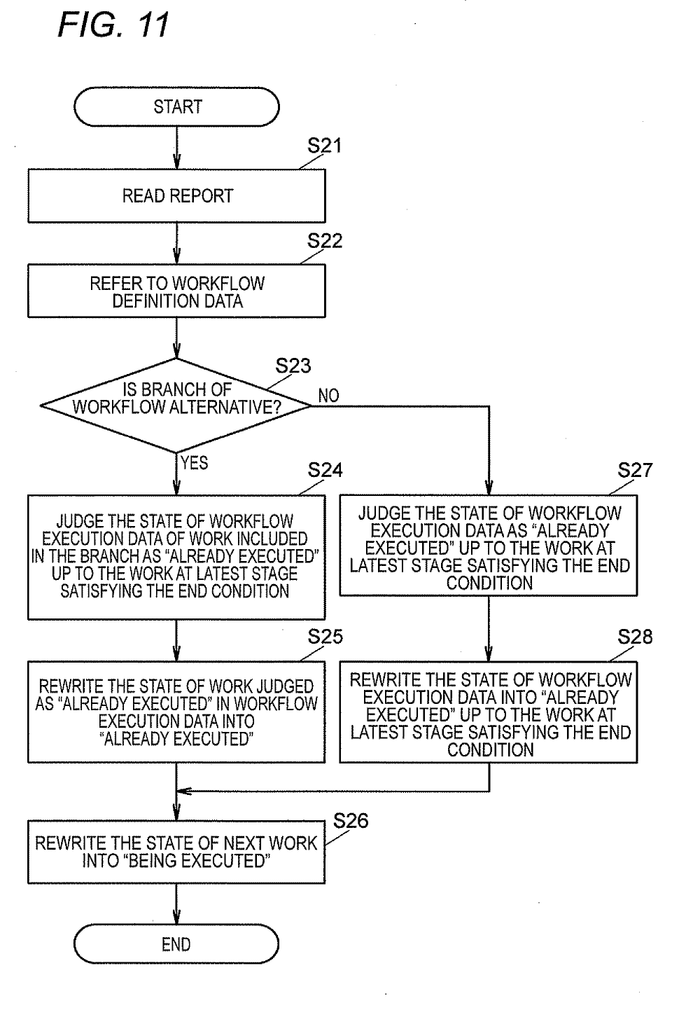

FIG. 11 is a flowchart showing an operation example of the workflow management system 5.

First of all, the report input section 10C converts the information received from the multifunction device 2 into the written information such as text data through the OCR and confirms the work corresponding to the written information and the content of written information (S21).

Next, the work state determination section 10D refers to the workflow definition data 113C as shown in FIG. 9 (S22), and if the branch exists in the workflow and is alternative (S23), determines the works 1, 2 and 5 included in the branch up to the work at the latest stage satisfying the end condition in accordance with the content of the note 200 of the report 20 confirmed at step S21, that is, the work 5 in which the note 200 is written, as already executed (S24).

Next, the workflow execution data management section 10A makes the state of the work determined as already executed by the work state determination section 10D at step S24 as “already executed” (S25), and makes the state of the next work of the work in which the state of the work is made “already executed” at step S25 as “being executed”, and rewrites the workflow execution data 112E into the workflow execution data 113E as shown in FIG. 10B (S26).

Also, if the branch exists in the workflow and is not alternative (S23: No), the work state determination section 10D determines the works 1 to 5 up to the work at the latest stage satisfying the end condition in accordance with the content of the note 200 of the report 20 confirmed at step S21, that is, the work 5 in which the note 200 is written, as already executed (S27).

Next, the workflow execution data management section 10A makes the state of the work determined as “already executed” by the work state determination section 10D at step S28 as “already executed” (S28), and the procedure goes to step S26.

### Fourth Exemplary Embodiment

A fourth exemplary embodiment is different from the first exemplary embodiment in considering the workflow definition data 111C by adding an execution type as will be described later.

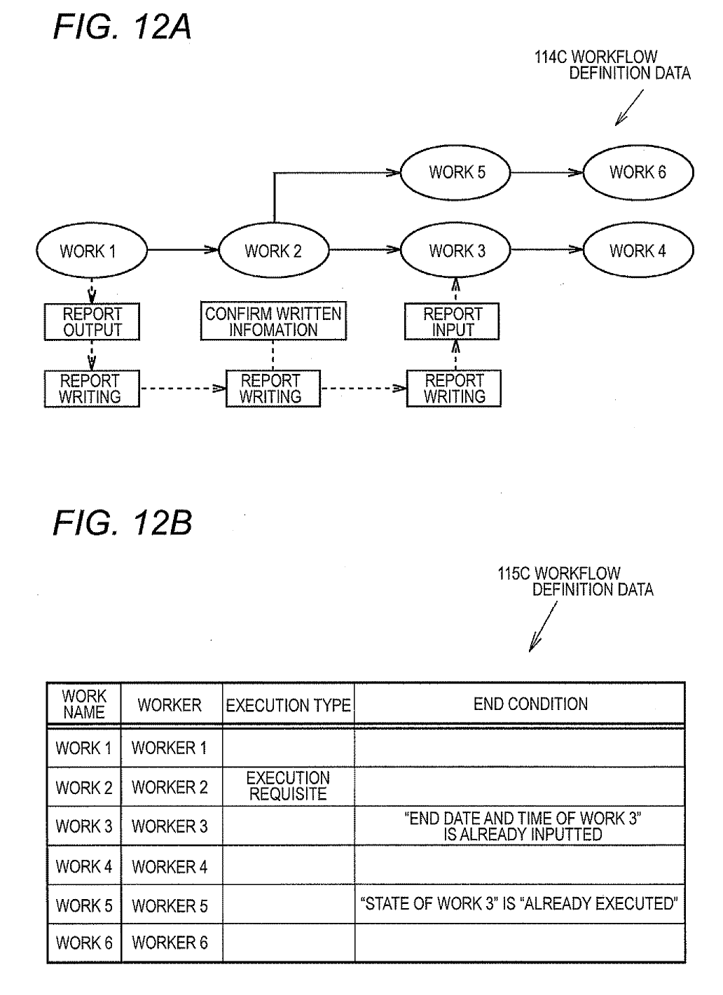

FIGS. 12A and 12B are schematic diagrams showing a configuration example of the workflow definition data 11C stored in the storage section 11 of the workflow management server apparatus 1 according to the fourth exemplary embodiment of the invention.

The workflow definition data 114C is the data defining a procedure of the works 1 to 6, and is defined to proceed in the sequence of work 1 and work 2, branch to work 3 or work 5, and respectively proceed to work 4 or work 6, for example, as shown in FIG. 12A. When proceeding from work 2 to work 3 or work 5, both works may be executed, or only the workflow following the ahead going work may be executed.

Also, the workflow definition data 114C is defined such that the report output and the report writing are executed by the worker of the work 1 in the work 1, the report writing is similarly executed in the works 2 and 3, and the report input is executed by the worker of the work 3 in the work 3. Also, the definition of the report output, report input and report writing operations is not made beforehand, but may be additionally made in accordance with the operation of the worker.

The workflow definition data 115C has a work name indicating the name of work included in the workflow, a worker indicating the user who executes each work, the kind of work to be executed, for example, the execution type defining the “execution requisite” indicating the work to confirm the electronic document including the written information created from the report 20 inputted at the terminal device 3, or the electronic document related to the work, and the end condition indicating the condition required to end the state of work, as shown in FIG. 12B.

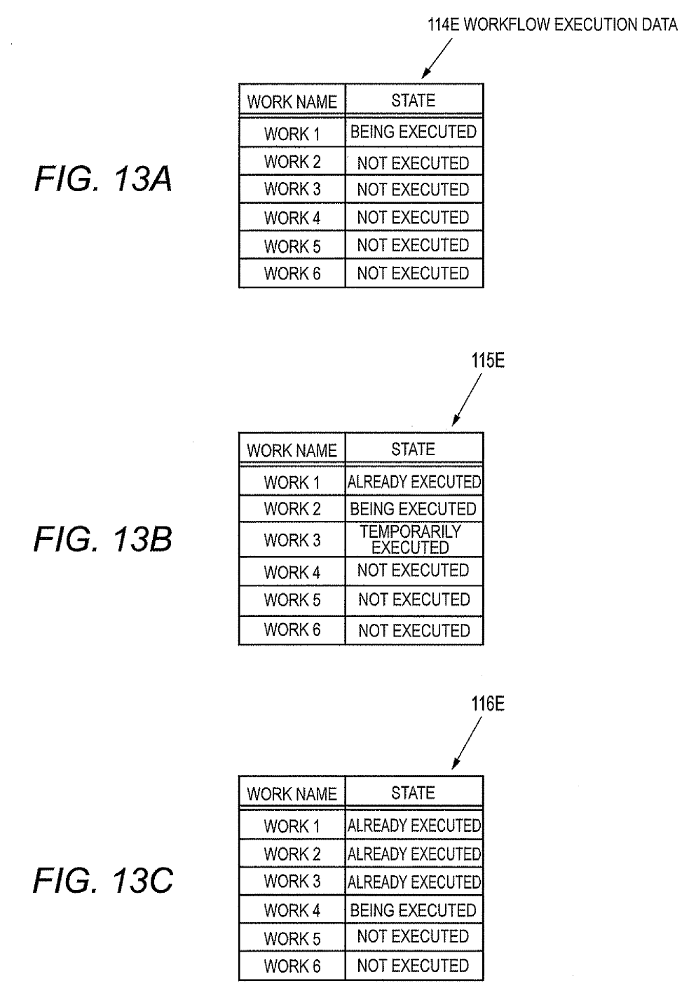

FIGS. 13A to 13C are schematic diagrams showing a configuration example of the workflow execution data 11E stored in the storage section 11 of the workflow management server apparatus 1.

The workflow execution data 114E as shown in FIG. 13A indicates the state of workflow execution data when the work 1 is being executed, in which the works following the work 2 are not yet executed when the works 1 to 6 proceed in the sequence as shown in FIG. 12A, for example.

The workflow execution data 115E as shown in FIG. 13B indicates the state that the work 4 is actually being executed, but the work 2 not satisfying the condition of the execution type is indicated as being executed, the work 3 satisfying both the execution type and the end condition is indicated as temporarily executed, because the work 2 at the previous stage is not already executed, and the works 4 to 6 are indicated as not yet executed.

The workflow execution data 116E as shown in FIG. 13C indicates the state that the work 2 is confirmed at the terminal device 3 by the user and satisfies the condition of the execution type “execution requisite”, the work 2 completing the execution and the work 3 temporarily executed are indicated as already executed, and the work 4 is indicated as being executed.

(Operation of Workflow Management System)

The works 1 to 3 are executed for the outputted report 20 in the sequence of the workers 1 to 3 in the same way as the first exemplary embodiment, in which the note 200 is written into the report 20 as shown in FIG. 3. In addition to the note 200 as shown in FIG. 3, the worker 3 further writes, and then inputs the report 20 into the multifunction device 2. The multifunction device 2 reads the report 20, and sends the read information to the workflow management server apparatus 1.

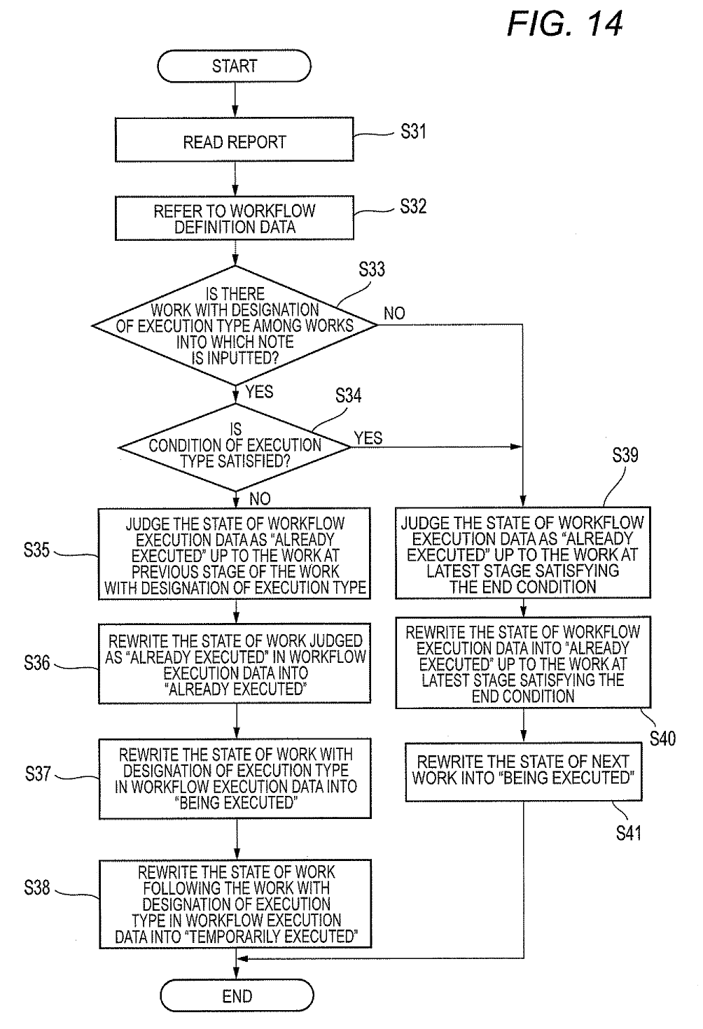

FIG. 14 is a flowchart showing an operation example of the workflow management system 5.

First of all, the report input section 10C converts the information received from the multifunction device 2 into the written information such as text data through the OCR and confirms the work in which the written information is written and the content of written information (S31).

Next, the work state determination section 10D refers to the workflow definition data 115C as shown in FIG. 12B (S32), and if there is the work with the designation of the execution type in the work corresponding to the note 200 written into the report 20, for example, the work 2 with the designation of “execution requisite” (S33: Yes), and if the condition of the execution type is not satisfied (S34: No), that is, the written information of the work 2 is not confirmed at the terminal device 3, it determines up to the work at the previous stage of the work with the designation of the execution type, namely, the work 1 as already executed (S35).

Next, the workflow execution data management section 10A makes the state of the work determined as already executed by the work state determination section 10D at step S35 as “already executed” (S36), makes the state of the work with the designation of the execution type as “being executed” (S37), and makes the state of the work following the work with the designation of the execution type as “temporarily executed” (S38), and rewrites the workflow execution data 114E as shown in FIG. 13A into the workflow execution data 115E as shown in FIG. 13B.

Also, if there is no work with the designation of the execution type in the works corresponding to the note 200 written into the report 20 (S33: No), or the condition of the execution type is satisfied (S34: No), the work state determination section 10D determines the works up to the work at the latest stage satisfying the end condition in accordance with the content of the written information of the report 20 confirmed at step S31, for example, the end condition of the work 3 that the “end date and time of the work 3” is already inputted, that is, the work 3 in which the note 200 is written, as already executed (S39).

Next, the workflow execution data management section 10A makes the state of the work determined as “already executed” by the work state determination section 10D at step S39 as “already executed” (S40), and makes the state of the next work of the work in which the state of the work is made “already executed at step S40 as “being executed”, and rewrites the workflow execution data 115E into the workflow execution data 116E as shown in FIG. 13C (S41).

### Other Exemplary Embodiments

The invention is not limited to the above exemplary embodiments, but various modifications may be made without departing from the spirit or scope of the invention. For example, in addition to the execution type as indicated in the workflow definition data 115C, the execution condition defining whether the execution type is “execution requisite” or not may be added. For example, if the note written into the report is an amount of money, the execution type is changed to the “execution requisite” when the amount of money exceeds the preset amount. Also, it is possible to set not only the “execution requisite” but also the “execution optional” defining the work that may be omitted. Also, the forms of the first to fourth exemplary embodiments may be appropriately combined.

Also, the workflow execution data management section 10A, the report output section 10B, the report input section 10C and the work state determination section 10D for use in the above exemplary embodiments may be read from the storage medium such as CD-ROM into the storage section within the device, or downloaded from the server apparatus connected to the network such as the Internet into the storage section within the device. Also, section or all of the section for use in the above exemplary embodiments may be realized by the hardware such as ASIC.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a process for determining execution states of plural works which are performed in order, the process comprising:
inputting written information of a paper document, the written information being written by an operator of at least one of the plural works, and indicating contents of the at least one of the plural works;
determining execution states of the at least one of the plural works indicated in the written information, based on the input written information and the order of the plural works; and
updating work state information indicating execution states of the plural works based on the determination.

2. The computer readable medium according to claim 1, the process further comprising:
inputting designation of a work from among the plural works,
wherein the state determination is performed on the designated work and a work which is performed before the designated work.

3. The work state determination program according to claim 1,
wherein
each of the plural works in the written information has end conditions,
works which satisfy the conditions are determined to be already executed works, and
a work which is performed after a work, which is latest in the order among the already executed works, is determined as being executed.

4. A work state determination device for determining execution states of plural works which are performed in order, the process comprising:
an input section that inputs written information of a paper document, the written information being written by an operator of at least one of the plural works, and indicating contents of the at least one of the plural works;
a determination section that determines execution states of the at least one of the plural works indicated in the written information, based on the input written information and the order of the plural works; and
an update section that updates work state information indicating execution states of the plural works based on the determination.
